(19) United States
(12) Patent Application Publication
(10) Pub. No.: US 2015/0161910 A1
(43) Pub. Date: Jun. 11, 2015

(54) QUALITATIVE MEAL-SCORING SYSTEMS AND METHODS

(71) Applicant: YOPTI, LLC, Bellevue, WA (US)

(72) Inventor: Jonathan BAILOR, Kirkland, WA (US)

(21) Appl. No.: 14/562,417

(22) Filed: Dec. 5, 2014

Related U.S. Application Data
(60) Provisional application No. 61/913,792, filed on Dec. 9, 2013.

(51) Int. Cl. G09B 19/00

(52) U.S. Cl. CPC G09B 19/0092

(57) ABSTRACT

Meals may be scored according to serving-wise scoring functions that follow declining-benefits curves based at least in part on personalized-serving counts of several food groups.

### CROSS-REFERENCE TO RELATED APPLICATIONS

This application claims the benefit of priority to Provisional Patent Application No. 61/913,792; filed Dec. 9, 2013; titled QUALITATIVE MEAL-SCORING SYSTEMS AND METHODS; and naming inventor Jonathan BAILOR. The above-cited application is hereby incorporated by reference, in its entirety, for all purposes.

### FIELD

This disclosure is directed to the field of software, and more particularly to qualitative meal-scoring.

### BACKGROUND

Dieting is the practice of eating food in a regulated fashion to affect one's body weight, as well as one's fitness, health, and appearance. Dieting is often used in combination with physical exercise to lose weight in those who are overweight or obese. Diets can also be used to maintain a stable body weight.

Diets to promote weight loss are generally directed to restricting an individual's caloric intake to create conditions in which the individual's body is expending more energy in work and metabolism than it is consuming from food or other nutritional supplements. Some weight-loss diets de-emphasize certain macronutrients (e.g., low-fat and low-carbohydrate diets) or food groups, while others maintain a more typical mix of foods in smaller portions than are typical for a given individual.

A common approach to weight-loss dieting involves setting a daily budget, denominated in calories or in an abstract point system derived from calories, and counting calories or points as they are consumed throughout the day. Other diets measure and/or categorize foods according to a non-caloric metric such as glycemic index. Detailed lists of acceptable and/or unacceptable foods are another common feature of weight-loss diets.

Weight-loss diets are often effective at helping individuals lose moderate amounts of weight during the early weeks and months of a diet. However, many individuals will regain lost weight in the months or years following their initial weight loss.

There are undoubtedly many reasons why weight-loss diets are ineffective at promoting long-term weight control, health, and happiness. However, many diets may be less effective than they could otherwise be because they suffer from problems such as some or all of the following.
They focus on quantities (e.g., calories) that are relatively easy to measure and count, but that may not correlate well to improved health outcomes. Measuring precise quantities can also imply a false correlation with improved outcomes. For example, a 3-ounce serving of cod might have 89 calories, while a 3-ounce serving of halibut might have 119 calories. If a diet is focused on measuring and restricting quantities of calories, then a dieter would be led to believe that eating the serving of halibut is 33% worse than eating the serving of cod. However, there may not be a meaningful distinction between the two servings of fish in terms of improved health outcomes.
They focus on lists of acceptable or unacceptable foods that may be specific to a particular country, region, ethnicity, or other population segment, and that consequently may not translate well to other countries, regions, ethnicities, or other population segments.
They are proscriptive (e.g., you must/must not eat at least/no more than X servings of Y) and create an antagonistic relationship between the dieter and the food they consume, as when consuming a portion of food also consumes a limited budget of points or calories that the user is allowed throughout the day.
Relatedly, they require tedious record keeping and are otherwise not enjoyable to engage in over the long term, as when eating a meal also requires updating a spreadsheet-like log of foods consumed.

### BRIEF DESCRIPTION OF THE DRAWINGS

FIGS. 1A-B illustrate various illustrative food groups in accordance with one embodiment.

FIG. 2 illustrates a food-group scoring data routine for determining one or more serving-wise scoring functions for a given food group over a given period of time, such as may be performed by a meal-scoring device in accordance with one embodiment.

FIG. 3 illustrates a meals-scoring routine for scoring one or more meals consumed by a given individual in a given period of time, such as may be performed by a meal-scoring device in accordance with one embodiment.

FIG. 4 illustrates a serving-wise scoring function subroutine for determining a food-group score for a given set of servings of a given food group having multiple subgroups, such as may be performed by a meal-scoring device in accordance with one embodiment.

FIG. 5 illustrates a serving-wise single-subgroup scoring function subroutine for determining a food-group score for a given set of servings of a given food group having a single subgroup, such as may be performed by a meal-scoring device in accordance with one embodiment.

FIG. 6 illustrates a serving-score subroutine for determining a serving score for a given serving count based on a given serving-wise subgroup scoring function, such as may be performed by a meal-scoring device in accordance with one embodiment.

FIG. 7 illustrates a meal-scoring routine for scoring a meal consumed by an individual during a period of time, such as may be performed by a meal-scoring device in accordance with one embodiment.

FIG. 8 illustrates a subroutine for determining an individual-serving benefits-score that measures qualitative benefits associated with the given serving consumed during the given period of time based at least in part on a given maximum-benefit score and a given serving-wise declining-benefits function, such as may be performed by a meal-scoring device in accordance with one embodiment.

FIG. 9 illustrates several components of an exemplary meal-scoring device in accordance with one embodiment.

### DESCRIPTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

As discussed further below, in various embodiments, meals may be scored according to scoring functions that follow declining-benefits curves based at least in part on personalized-serving counts of several broad food groups.

As discussed herein, in various embodiments, a processor and/or processing device may be configured (e.g., via non-transitory computer-readable storage media) to perform a first method for scoring a meal consumed by an individual during a period of time, the first method including steps similar to some or all of the following:
obtaining a meal manifest corresponding to the period of time, the meal manifest including a servings count that measures servings of a food of an indicated food group that the individual consumed during the period of time;
determining, based at least in part on the period of time, a maximum-benefit score and a serving-wise declining-benefits function corresponding to the indicated food group;
determining individual-serving benefits-scores that respectively measure qualitative benefits associated with the servings consumed during the period of time, such that a first serving is qualitatively-measured according to the maximum-benefit score and subsequent servings are qualitatively-measured according to the declining-benefits function;
determining a collective-servings score measuring a qualitative benefit associated with the servings consumed during the period of time, the collective-servings score being determined based at least in part on an accumulation of the individual-serving benefits-scores; and/or
associating the collective-servings score with at least the individual and the period of time in a data store.

In some cases, determining the declining-benefits function may include elements similar to some or all of the following:
determining a serving-wise decay rate based at least in part on a duration of the period of time, such that shorter durations are associated with faster decay rates;
determining a serving-wise decay rate based at least in part on a measure of variety among various foods of the indicated food group, such that food groups having higher measures of variety are associated with slower decay rates; and/or
determining a serving-wise decay rate based at least in part on a measure of expected weight and/or health outcomes associated with the indicated food group, such that food groups having better expected weight and/or health outcomes are associated with slower decay rates.

In some cases, determining at least one of the individual-serving benefits-scores includes determining that at least one of the servings exceeds a maximum non-detrimental serving count, and consequently, assigning a negative benefits score to the at least one of the servings.

In some cases, determining the collective-servings score includes, when a duration of the period of time is determined to exceed a predetermined threshold:
determining a personal adjustment factor based at least in part on a personal characteristic of the individual; and/or
adjusting the accumulation of the individual-serving benefits-scores according to the personal adjustment factor.

Described more fully below are many additional details, variations, and embodiments that may or may not include some or all of the steps, features, and/or functionality described above.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

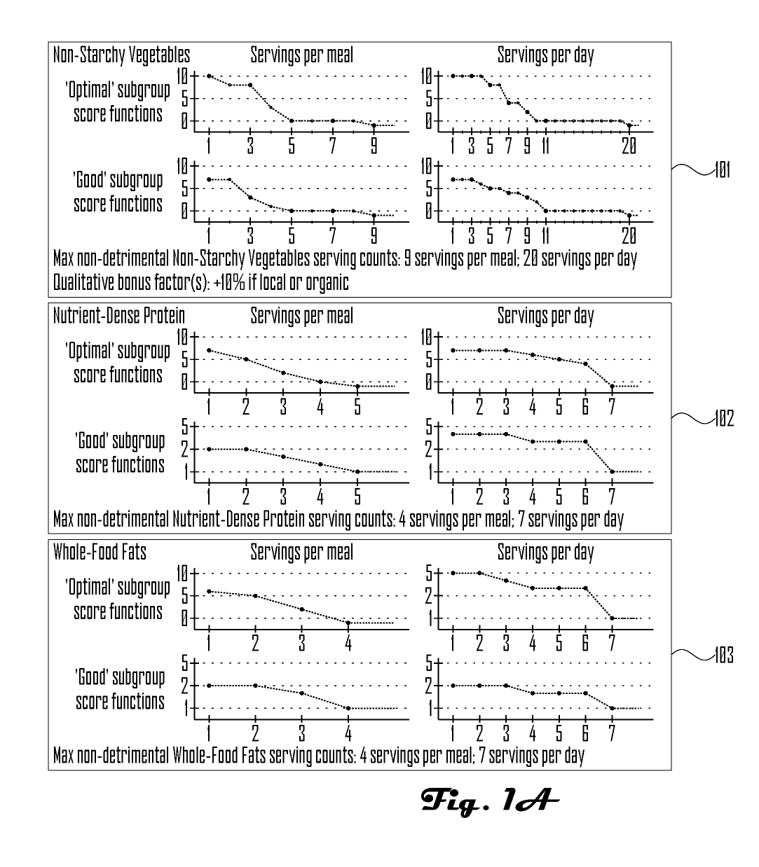

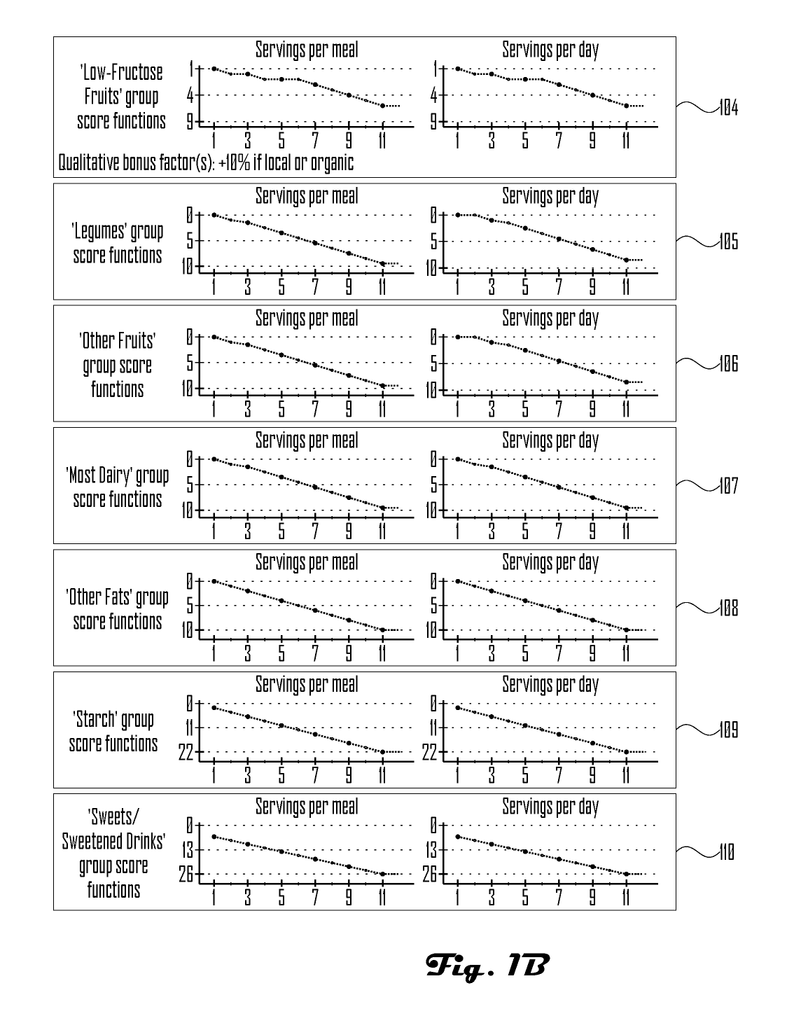

FIGS. 1A-B illustrate various illustrative food groups in accordance with one embodiment. Generally, each food group is associated with certain types of foods and one or more serving-wise scoring functions, each of which provides scores that decline on a serving-by-serving basis for a certain period of time (e.g., per meal, per day, and the like). Some food groups include two or more subgroups, each with its own set of serving-wise scoring functions for certain periods of time.

For purposes of this disclosure, food groups that do not include two or more subgroups (e.g., low-fructose fruits' food group 104, ‘legumes’ food group 105, and the like) are considered to include a single “subgroup” that is coextensive with the group. For example, for purposes of this disclosure, ‘low-fructose fruits’ food group 104 is considered to include one subgroup that is associated with the same foods and serving-wise scoring functions as the group itself.

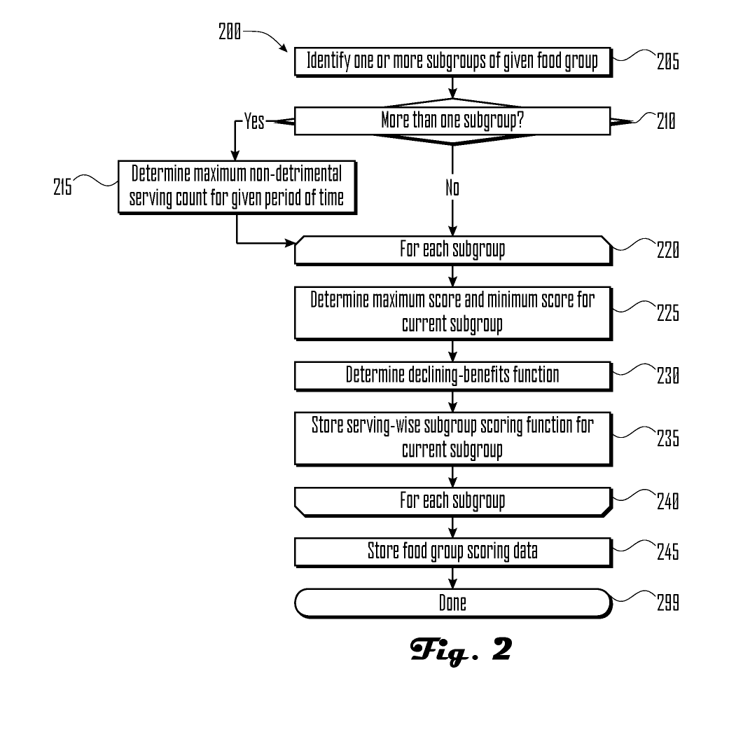

The score values associated with the serving-wise scoring functions are discussed further in relation to block 225 (see FIG. 2, discussed below). As illustrated in FIG. 1, scores generally decline as the count of servings of a particular group and/or subgroup increase within a given time period, reflecting the reality that consuming an excess quantity of any one food group is unlikely to be associated with positive weight and/or health outcomes. Serving-wise declining-benefits functions are shown and discussed further in block 230 (see FIG. 2, discussed below).

In various embodiments, serving-wise scoring functions and food groups such as those illustrated in FIG. 1 may be employed, as discussed further below, to evaluate or score one or more meals that were or may be consumed by an individual during a TimePeriod.

In some embodiments, such a TimePeriod may be denominated in a traditional measure of time, such as hours, minutes, or days. In some embodiments, such a TimePeriod period may also be denominated in an alternative measure such as by counting meals or sittings. For example, in other embodiments, “per meal” serving-wise scoring functions such as those shown in FIG. 1 may be equivalently expressed as “per N hours” serving-wise scoring functions, where “N hours” is a period of time (e.g., 4 or 6 hours) that corresponds to a customary interval between meals.

The groups, subgroups, serving-wise scoring functions, and time periods illustrated in FIG. 1 and described below are merely illustrative of one possible embodiment. Other embodiments may employ more, fewer, and/or different food groups, subgroups, serving-wise scoring functions, time periods, and the like. Indeed, in some embodiments, serving-wise scoring functions and/or food groups may be adjusted from time to time to reflect new research into diet and/or nutrition.

The illustrative ‘non-starchy vegetables’ food group 101 includes two subgroups: ‘optimal’ and ‘good’. The non-starchy vegetables (optimal) subgroup includes foods such as arugula, bok choy, brussels sprouts, chard, garlic, greens, kale, romaine lettuce, spinach, watercress, and other deep green nonstarchy vegetables. On a per meal basis, the first serving from the non-starchy vegetables (optimal) subgroup has a score of 10. Scores for subsequent servings from the non-starchy vegetables (optimal) subgroup during the same meal eventually decline to −1 starting with the 9th serving. In some embodiments, if the total count of servings from either the optimal or the good subgroups during one meal exceeds 8, then the 9th and subsequent servings of any non-starchy vegetables during that meal may each have scores of −1.

On a per day basis, the first serving from the non-starchy vegetables (optimal) subgroup has a score of 10. Scores for subsequent servings from the non-starchy vegetables (optimal) subgroup during the same day eventually decline to −1 starting with the 20th serving. In some embodiments, if the total count of servings from either the optimal or the good subgroups during one day exceeds 19, then the 20th and subsequent servings of any non-starchy vegetables during that day may each have scores of −1.

The non-starchy vegetables (good) subgroup includes foods such as other vegetables you could eat raw. On a per meal basis, the first serving from the non-starchy vegetables (good) subgroup has a score of 7. Scores for subsequent servings from the non-starchy vegetables (good) subgroup during the same meal eventually decline to −1 starting with the 9th serving. In some embodiments, if the total count of servings from either the optimal or the good subgroups during one meal exceeds 8, then the 9th and subsequent servings of any non-starchy vegetables during that meal may each have scores of −1.

On a per day basis, the first serving from the non-starchy vegetables (good) subgroup has a score of 7. Scores for subsequent servings from the non-starchy vegetables (good) subgroup during the same day eventually decline to −1 starting with the 20th serving. In some embodiments, if the total count of servings from either the optimal or the good subgroups during one day exceeds 19, then the 20th and subsequent servings of any non-starchy vegetables during that day may each have scores of −1.

If a given serving of non-starchy vegetables meets one or more qualitative criteria, a food-quality adjustment factor may be applied. If a given serving is indicated to be local or organic, then its serving score may be adjusted by +10%.

The illustrative ‘nutrient-dense protein’ food group 102 includes two subgroups: ‘optimal’ and ‘good’. The nutrient-dense protein (optimal) subgroup includes foods such as mollusks (e.g., oysters, clams, mussels); organ meats; and fatty fish (e.g., salmon, sardines, anchovies). On a per meal basis, the first serving from the nutrient-dense protein (optimal) subgroup has a score of 7. Scores for subsequent servings from the nutrient-dense protein (optimal) subgroup during the same meal eventually decline to −1 starting with the 5th serving. In some embodiments, if the total count of servings from either the optimal or the good subgroups during one meal exceeds 4, then the 5th and subsequent servings of any nutrient-dense protein during that meal may each have scores of −1.

On a per day basis, the first serving from the nutrient-dense protein (optimal) subgroup has a score of 7. Scores for subsequent servings from the nutrient-dense protein (optimal) subgroup during the same day eventually decline to −1 starting with the 7th serving. In some embodiments, if the total count of servings from either the optimal or the good subgroups during one day exceeds 6, then the 7th and subsequent servings of any nutrient-dense protein during that day may each have scores of −1.

The nutrient-dense protein (good) subgroup includes foods such as other unprocessed seafood, other unprocessed lean meats, unsweetened cottage cheese, unsweetened greek yogurt, and egg whites. On a per meal basis, the first serving from the nutrient-dense protein (good) subgroup has a score of 2. Scores for subsequent servings from the nutrient-dense protein (good) subgroup during the same meal eventually decline to −1 starting with the 5th serving. In some embodiments, if the total count of servings from either the optimal or the good subgroups during one meal exceeds 4, then the 5th and subsequent servings of any nutrient-dense protein during that meal may each have scores of −1.

On a per day basis, the first serving from the nutrient-dense protein (good) subgroup has a score of 4. Scores for subsequent servings from the nutrient-dense protein (good) subgroup during the same day eventually decline to −1 starting with the 7th serving. In some embodiments, if the total count of servings from either the optimal or the good subgroups during one day exceeds 6, then the 7th and subsequent servings of any nutrient-dense protein during that day may each have scores of −1.

The illustrative ‘whole-food fats’ food group 103 includes two subgroups: ‘optimal’ and ‘good’. The whole-food fats (optimal) subgroup includes foods such as coconut, cocoa, avocado, flax, chia, macadamias, and olives. On a per meal basis, the first serving from the whole-food fats (optimal) subgroup has a score of 6. Scores for subsequent servings from the whole-food fats (optimal) subgroup during the same meal eventually decline to −1 starting with the 4th serving. In some embodiments, if the total count of servings from either the optimal or the good subgroups during one meal exceeds 3, then the 4th and subsequent servings of any whole-food fats during that meal may each have scores of −1.

On a per day basis, the first serving from the whole-food fats (optimal) subgroup has a score of 5. Scores for subsequent servings from the whole-food fats (optimal) subgroup during the same day eventually decline to −1 starting with the 7th serving. In some embodiments, if the total count of servings from either the optimal or the good subgroups during one day exceeds 6, then the 7th and subsequent servings of any whole-food fats during that day may each have scores of −1.

The whole-food fats (good) subgroup includes foods such as eggs, most nuts (raw), and most seeds (raw). On a per meal basis, the first serving from the whole-food fats (good) subgroup has a score of 2. Scores for subsequent servings from the whole-food fats (good) subgroup during the same meal eventually decline to −1 starting with the 4th serving. In some embodiments, if the total count of servings from either the optimal or the good subgroups during one meal exceeds 3, then the 4th and subsequent servings of any whole-food fats during that meal may each have scores of −1.

On a per day basis, the first serving from the whole-food fats (good) subgroup has a score of 2. Scores for subsequent servings from the whole-food fats (good) subgroup during the same day eventually decline to −1 starting with the 7th serving. In some embodiments, if the total count of servings from either the optimal or the good subgroups during one day exceeds 6, then the 7th and subsequent servings of any whole-food fats during that day may each have scores of −1.

The illustrative ‘low-fructose fruits’ food group 104 includes one subgroup, which includes foods such as berries and citrus. On a per meal basis, the first serving from the low-fructose fruits group/subgroup has a score of 1. Scores for subsequent servings from the low-fructose fruits group/subgroup during the same meal eventually decline to −6 starting with the 11th serving.

On a per day basis, the first serving from the low-fructose fruits group/subgroup has a score of 1. Scores for subsequent servings from the low-fructose fruits group/subgroup during the same day eventually decline to −6 starting with the 11th serving.

If a given serving of low-fructose fruits meets one or more qualitative criteria, a food-quality adjustment factor may be applied. If a given serving is indicated to be local or organic, then its serving score may be adjusted by +10%.

The illustrative ‘legumes’ food group 105 includes one subgroup, which includes foods such as peas, beans, and lentils. On a per meal basis, the first serving from the legumes group/subgroup has a score of 0. Scores for subsequent servings from the legumes group/subgroup during the same meal eventually decline to −9.5 starting with the 11th serving.

On a per day basis, the first serving from the legumes group/subgroup has a score of 0. Scores for subsequent servings from the legumes group/subgroup during the same day eventually decline to −8.5 starting with the 11th serving.

The illustrative ‘other fruits’ food group 106 includes one subgroup, which includes foods such as Other Fruits. On a per meal basis, the first serving from the other fruits group/subgroup has a score of 0. Scores for subsequent servings from the other fruits group/subgroup during the same meal eventually decline to −9.5 starting with the 11th serving.

On a per day basis, the first serving from the other fruits group/subgroup has a score of 0. Scores for subsequent servings from the other fruits group/subgroup during the same day eventually decline to −8.5 starting with the 11th serving.

The illustrative ‘most dairy’ food group 107 includes one subgroup, which includes foods such as milk, cheese, and sour cream. On a per meal basis, the first serving from the most dairy group/subgroup has a score of 0. Scores for subsequent servings from the most dairy group/subgroup during the same meal eventually decline to −9.5 starting with the 11th serving.

On a per day basis, the first serving from the most dairy group/subgroup has a score of 0. Scores for subsequent servings from the most dairy group/subgroup during the same day eventually decline to −9.5 starting with the 11th serving.

The illustrative ‘other fats’ food group 108 includes one subgroup, which includes foods such as processed nuts and oils. On a per meal basis, the first serving from the other fats group/subgroup has a score of 0. Scores for subsequent servings from the other fats group/subgroup during the same meal eventually decline to −10 starting with the 11th serving.

On a per day basis, the first serving from the other fats group/subgroup has a score of 0. Scores for subsequent servings from the other fats group/subgroup during the same day eventually decline to −10 starting with the 11th serving.

The illustrative ‘starch’ food group 109 includes one subgroup, which includes foods such as potatoes, rice, and pasta. On a per meal basis, the first serving from the starch group/subgroup has a score of −2. Scores for subsequent servings from the starch group/subgroup during the same meal eventually decline to −22 starting with the 11th serving.

On a per day basis, the first serving from the starch group/subgroup has a score of −2. Scores for subsequent servings from the starch group/subgroup during the same day eventually decline to −22 starting with the 11th serving.

The illustrative ‘sweets/sweetened drinks’ food group 110 includes one subgroup, which includes foods such as soda, candy, pastries, and ice cream. On a per meal basis, the first serving from the sweets/sweetened drinks group/subgroup has a score of −6. Scores for subsequent servings from the sweets/sweetened drinks group/subgroup during the same meal eventually decline to −26 starting with the 11th serving.

On a per day basis, the first serving from the sweets/sweetened drinks group/subgroup has a score of −6. Scores for subsequent servings from the sweets/sweetened drinks group/subgroup during the same day eventually decline to −26 starting with the 11th serving.

FIG. 2 illustrates a food-group scoring data routine 200 for determining one or more serving-wise scoring functions for a given food group over a given period of time, such as may be performed by a meal-scoring device 900 in accordance with one embodiment.

In block 205, food-group scoring data routine 200 identifies one or more subgroups of the given food group. For example, when given ‘non-starchy vegetables’ food group 101 (see FIG. 1, discussed above), food-group scoring data routine 200 may determine that there are two subgroups. Similarly, when given low-fructose fruits' food group 104 (see FIG. 1, discussed above), food-group scoring data routine 200 may determine that there is only one ‘subgroup’, which is coextensive with the group itself.

In decision block 210, food-group scoring data routine 200 determines whether more than one subgroup was identified in block 205. If so, then food-group scoring data routine 200 proceeds to block 215. If only one subgroup was identified, then food-group scoring data routine 200 proceeds to opening loop block 220.

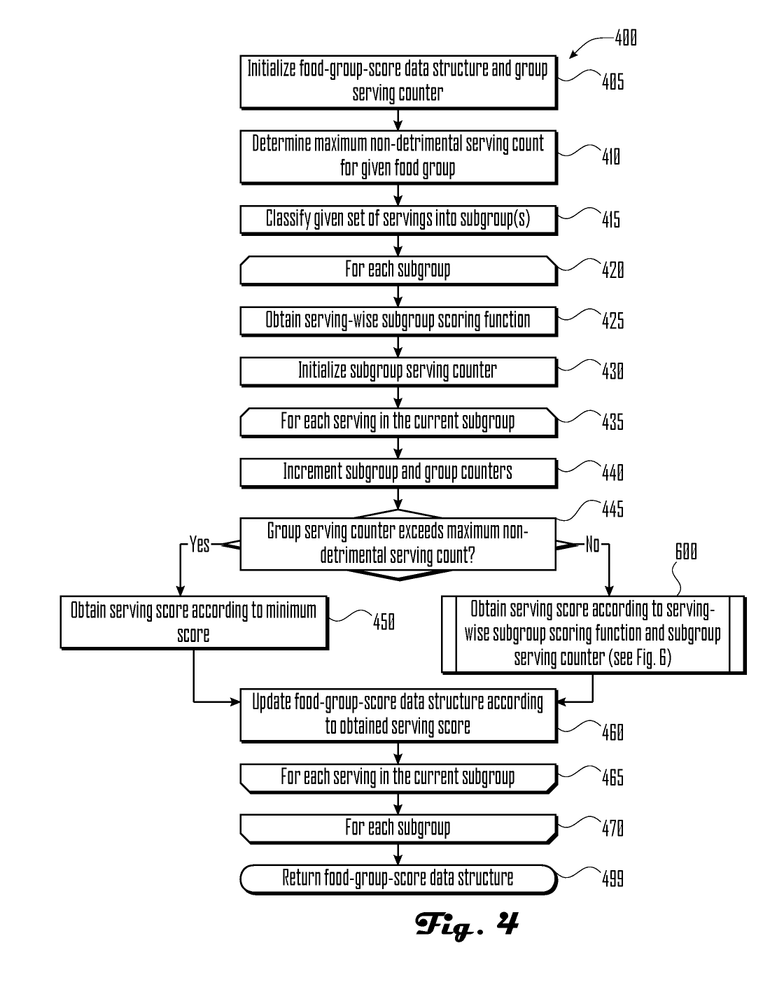

In block 215, food-group scoring data routine 200 determines a maximum non-detrimental serving count for the given period of time and the given food group. For example, when given ‘non-starchy vegetables’ food group 101 (see FIG. 1, discussed above) and a TimePeriod of one meal, food-group scoring data routine 200 may determine that the 9th and subsequent servings of any food in the group (regardless of subgroup) should have a score of −1. This group-wide maximum non-detrimental serving count mechanism is shown and discussed in further detail in serving-wise scoring function subroutine 400 (see FIG. 4, discussed below).

Beginning in opening loop block 220, food-group scoring data routine 200 processes each subgroup in turn.

In block 225, food-group scoring data routine 200 determines a maximum score and a minimum score for the current subgroup. Generally, the minimum score and the maximum score are determined based at least in part on likely weight and/or health outcomes associated with consumption of the given food group over the given period of time. The score values associated with a serving-wise scoring function do not necessarily correlate directly to a quantitative measure such as calories. Rather, score values are meaningful primarily in relation to one another, with positive scores being generally associated with positive weight and/or health outcomes and negative scores being generally associated with negative weight and/or health outcomes.

In block 230, food-group scoring data routine 200 determines a serving-wise declining-benefits function from the maximum score to the minimum score. In some embodiments, the curve according to which serving-wise scores decline may depend on various factors, including factors such as some or all of the following.
the duration of the given period of time (with shorter durations being associated with higher rates of decline);
the variety of foods included within the current subgroup (with subgroups including a wider variety of foods being associated with lower rates of decline); as well as
weight and/or health outcomes associated with increased consumption of foods within the current subgroup.

In block 235, food-group scoring data routine 200 stores a serving-wise subgroup scoring function for the current subgroup based at least in part on the maximum non-detrimental serving count determined in block 215 (if any), the maximum score and the minimum score determined in block 225, the given period of time, and the serving-wise declining-benefits function determined in block 230.

In ending loop block 240, food-group scoring data routine 200 iterates back to opening loop block 220 to process the next subgroup, if any.

In block 245, food-group scoring data routine 200 stores the food group scoring data (e.g. in qualitative meal-scoring database 940) for subsequent use.

Food-group scoring data routine 200 ends in ending block 299.

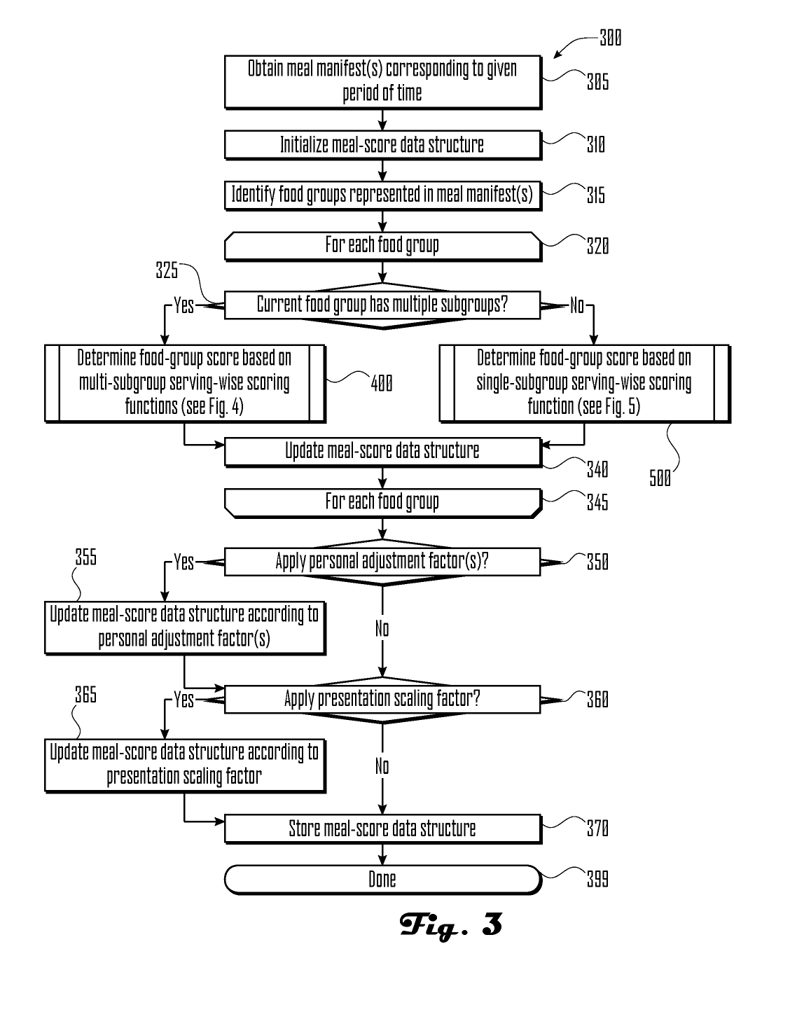

FIG. 3 illustrates a meals-scoring routine 300 for scoring one or more meals consumed by a given individual in a given period of time, such as may be performed by a meal-scoring device 900 in accordance with one embodiment.

In block 305, meals-scoring routine 300 obtains one or more meal manifest(s) corresponding to one or more meals consumed by the given individual in the given period of time. As the term is used herein, a “meal manifest” refers to data that describes serving counts of various foods or food groups that the given individual consumed during the given period of time. In some embodiments, a meal manifest may be entered manually by the given individual. In other embodiments, the given individual may take a picture of his or her meal and submit it to a meal-scoring service along with serving- and/or food-group-related metadata, such that the meal-scoring service may determine a meal manifest by an automatic and/or manual process based on the image and/or metadata.

In some embodiments, the size of a serving may be determined based at least in part on physical characteristics of the given individual, such that, for example, eight ounces of chard may be considered one serving for a relatively large individual, while five ounces of chard may be considered one serving for a relatively small individual. In some embodiments, an individual may be encouraged to use the size of his or her hand, fist, and/or fingers to help the individual evaluate serving counts.

In one embodiment, a meal manifest may include data similar to some or all of the following.

“non-starchy vegetables (good)”: 2
“nutrient-dense protein (optimal)”: 1
“legumes”: 1
“starch”: 1
“sweets/sweetened drinks”: 2

In some embodiments, a meal manifest may additionally include various metadata about some or all of the servings, such as whether a given serving was locally sourced and/or organic.

In block 310, meals-scoring routine 300 initializes a meal-score data structure. For example, in various embodiments, such a meal-score data structure may include one or more lists, arrays, hashes, records, objects, or other suitable data structures.

In block 315, meals-scoring routine 300 identifies one or more food groups represented in the meal manifest(s) obtained in block 305. In some embodiments, the given individual may have provided metadata from which one or more food groups may be identified. In other embodiments, one or more food groups may be identified automatically using image-recognition, computer vision, machine learning, and/or image processing techniques. In some embodiments, the identification of food groups may be submitted for processing by a worker associated with an online crowdsourcing marketplace, such as the Amazon Mechanical Turk, provided by Amazon.com, Inc. of Seattle Wash., or the like. In other embodiments, one or more food groups may be identified by any suitable process.

Beginning in opening loop block 320, meals-scoring routine 300 processes each food group in turn.

In decision block 325, meals-scoring routine 300 determines whether the current food group has multiple subgroups. If so, meals-scoring routine 300 proceeds to subroutine block 400. Otherwise, meals-scoring routine 300 proceeds to subroutine block 500.

In subroutine block 400, meals-scoring routine 300 calls subroutine 400 (see FIG. 4, discussed below) to determine a food-group score for the current food group based at least in part on multi-subgroup serving-wise scoring functions associated with the current food group and the given period of time.

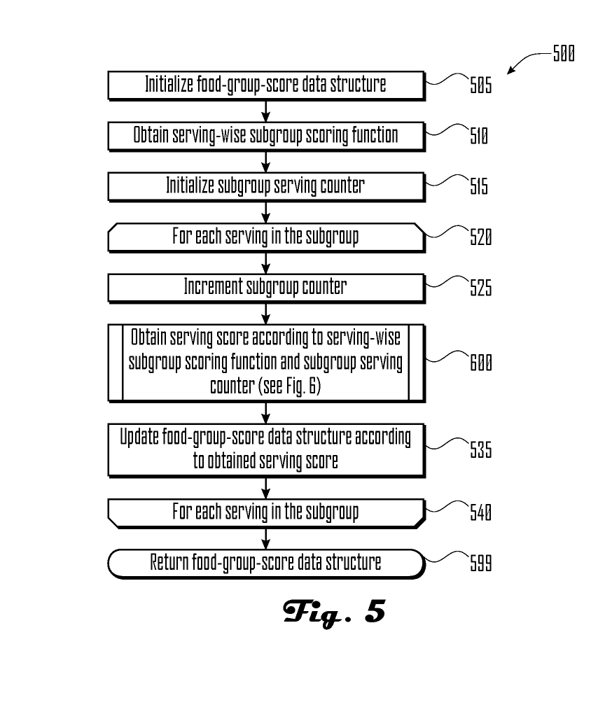

In subroutine block 500, meals-scoring routine 300 calls subroutine 500 (see FIG. 5, discussed below) to determine a food-group score for the current food group based at least in part on a single-subgroup serving-wise scoring function associated with the current food group and the given period of time.

In block 340, meals-scoring routine 300 updates the meal-score data structure initialized in block 310 according to the food-group score determined in serving-wise scoring function subroutine 400.

In ending loop block 345, meals-scoring routine 300 iterates back to opening loop block 320 to process the next food group, if any.

In decision block 350, meals-scoring routine 300 determines whether to apply one or more personal adjustment factors. In some embodiments, personal adjustment factors may be multipliers that are applied only when scoring over a certain period of time. For example, in one embodiment, personal adjustment factors may not be applied on a per-meal basis, but may be applied on a per-day basis. As a result, per-meal scores may be comparable from individual to individual, whereas per-day scores would be based in part on individualized factors and may not be comparable between individuals.

In various embodiments, personal adjustment factors may include factors that are associated with health outcomes, such as some or all of the following.
sleep
perceived stress
hydration
age
consistency (e.g., achieving a daily score of at least X points for Y days in a row)
personal best
tobacco, drug, and/or alcohol use

For example, a personal adjustment factor related to sleep might apply a multiplier of 1.05 if the given individual reports 8 or more hours of sleep, or 0.95 for 7 or fewer hours of sleep.

If in decision block 350, meals-scoring routine 300 determines to apply one or more personal adjustment factors, then meals-scoring routine 300 proceeds to block 355. Otherwise, meals-scoring routine 300 proceeds to decision block 360.

In block 355, meals-scoring routine 300 updates the meal-score data structure according to the one or more personal adjustment factor(s).

In decision block 360, meals-scoring routine 300 determines whether to apply a presentation scaling factor. In some embodiments, the raw score values as illustrated in food groups 1 (and possible modified according to one or more personal adjustment factors) may be scaled according to an arbitrary multiplier or other scaling factor for presentation to the given individual. For example, in one embodiment, a presentation scaling factor may be chosen such that a highly-scoring meal or day of meals would tend to approach a round number (e.g., 100, 1000, 2000, or the like).

If in decision block 360, meals-scoring routine 300 determines to apply a presentation scaling factor, then meals-scoring routine 300 proceeds to block 365. Otherwise, meals-scoring routine 300 proceeds to block 370.

In block 365, meals-scoring routine 300 updates the meal-score data structure according to presentation scaling factor.

In block 370, meals-scoring routine 300 stores the meal-score data structure (e.g., in qualitative meal-scoring database 940) for subsequent presentation to and/or use by the given individual.

Meals-scoring routine 300 ends in ending block 399.

FIG. 4 illustrates a serving-wise scoring function subroutine 400 for determining a food-group score for a given set of servings of a given food group having multiple subgroups, such as may be performed by a meal-scoring device 900 in accordance with one embodiment.

In block 405, serving-wise scoring function subroutine 400 initializes a food-group-score data structure and a group serving counter. For example, in various embodiments, such a food-group-score data structure may include one or more lists, arrays, hashes, records, objects, or other suitable data structures.

In block 410, serving-wise scoring function subroutine 400 determines a maximum non-detrimental serving count for given food group. Typically, the maximum non-detrimental serving count is indicated via metadata associated with the given food group. Such a maximum non-detrimental serving count is also discussed in relation to block 215 (see FIG. 2, discussed above).

In block 415, serving-wise scoring function subroutine 400 classifies the given set of servings into two or more subgroup(s) of the given food group.

Beginning in opening loop block 420, serving-wise scoring function subroutine 400 processes each subgroup in turn.

In block 425, serving-wise scoring function subroutine 400 obtains a serving-wise subgroup scoring function associated with the current subgroup.

In block 430, serving-wise scoring function subroutine 400 initializes a subgroup serving counter to count servings of the current subgroup.

Beginning in opening loop block 435, serving-wise scoring function subroutine 400 processes each serving in the current subgroup in turn.

In block 440, serving-wise scoring function subroutine 400 increments the subgroup and group counters.

In decision block 445, serving-wise scoring function subroutine 400 determines whether the current value of the group serving counter exceeds the maximum non-detrimental serving count determined in block 410. If so, then serving-wise scoring function subroutine 400 proceeds to block 450. Otherwise, serving-wise scoring function subroutine 400 proceeds to subroutine block 600.

In block 450, serving-wise scoring function subroutine 400 obtains a serving score according to a minimum score associated with the current subgroup. Minimum scores are discussed in relation to block 225 (see FIG. 2, discussed above).

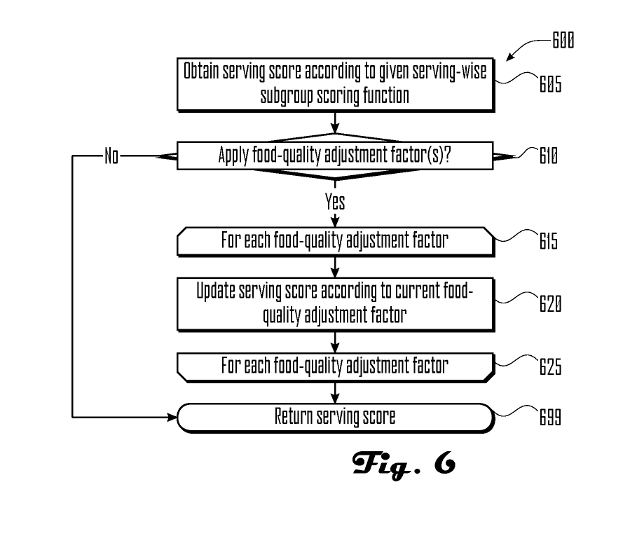

In subroutine block 600, serving-wise scoring function subroutine 400 calls subroutine 600 (see FIG. 6, discussed below) to obtain a serving score according to a serving-wise subgroup scoring function and the subgroup serving counter incremented in block 440.

In block 460, serving-wise scoring function subroutine 400 updates the food-group-score data structure according to the serving score obtained in subroutine block 600.

In ending loop block 465, serving-wise scoring function subroutine 400 iterates back to opening loop block 435 to process the next serving in the current subgroup, if any.

In ending loop block 470, serving-wise scoring function subroutine 400 iterates back to opening loop block 420 to process the next subgroup, if any.

Serving-wise scoring function subroutine 400 ends in ending block 499, returning the food-group-score data structure to the caller.

FIG. 5 illustrates a serving-wise single-subgroup scoring function subroutine 500 for determining a food-group score for a given set of servings of a given food group having a single subgroup, such as may be performed by a meal-scoring device 900 in accordance with one embodiment.

In block 505, serving-wise single-subgroup scoring function subroutine 500 initializes a food-group-score data structure. For example, in various embodiments, such a food-group-score data structure may include one or more lists, arrays, hashes, records, objects, or other suitable data structures.

In block 510, serving-wise single-subgroup scoring function subroutine 500 obtains a serving-wise subgroup scoring function associated with the subgroup.

In block 515, serving-wise single-subgroup scoring function subroutine 500 initializes a subgroup serving counter to count servings of the subgroup.

Beginning in opening loop block 520, serving-wise single-subgroup scoring function subroutine 500 processes each serving in the subgroup in turn.

In block 525, serving-wise single-subgroup scoring function subroutine 500 increments the subgroup counter.

In subroutine block 600, serving-wise single-subgroup scoring function subroutine 500 calls subroutine 600 (see FIG. 6, discussed below) to obtain a serving score according to a serving-wise subgroup scoring function and the subgroup serving counter incremented in block 525.

In block 535, serving-wise single-subgroup scoring function subroutine 500 updates the food-group-score data structure according to the serving score obtained in subroutine block 600.

In ending loop block 540, serving-wise single-subgroup scoring function subroutine 500 iterates back to opening loop block 520 to process the next serving in the subgroup, if any.

Serving-wise single-subgroup scoring function subroutine 500 ends in ending block 599, returning the food-group-score data structure to the caller.

FIG. 6 illustrates a serving-score subroutine 600 for determining a serving score for a given serving count based on a given serving-wise subgroup scoring function, such as may be performed by a meal-scoring device 900 in accordance with one embodiment.

In block 605, serving-score subroutine 600 obtains a serving score according to the given serving-wise subgroup scoring function. For example, if given a serving count of 3 and a serving-wise scoring function similar to the ‘per meal’ serving-wise scoring function of the ‘optimal’ subgroup of ‘non-starchy vegetables’ food group 101 (see FIG. 1, discussed above), then in block 605, serving-score subroutine 600 would obtain a serving score of 8.

In decision block 610, serving-score subroutine 600 determines whether to apply one or more food-quality adjustment factors. In some embodiments, a serving score may be adjusted according to various qualitative factors of a particular serving that may correlate to improved health outcomes. For example, in one embodiment, a serving score may be adjusted upwards by 10% if the serving in question was of organic and/or locally sourced food.

If in decision block 610, serving-score subroutine 600 determines that the serving in question meets one or more criteria associated with one or more food-quality adjustment factors, then serving-score subroutine 600 proceeds to opening loop block 615. Otherwise, serving-score subroutine 600 proceeds to ending block 699.

Beginning in opening loop block 615, serving-score subroutine 600 processes each food-quality adjustment factor in turn.

In block 620, serving-score subroutine 600 updates the serving score according to the current food-quality adjustment factor.

In ending loop block 625, serving-score subroutine 600 iterates back to opening loop block 615 to process the next food-quality adjustment factor, if any.

Serving-score subroutine 600 ends in ending block 699, returning the serving score to the caller.

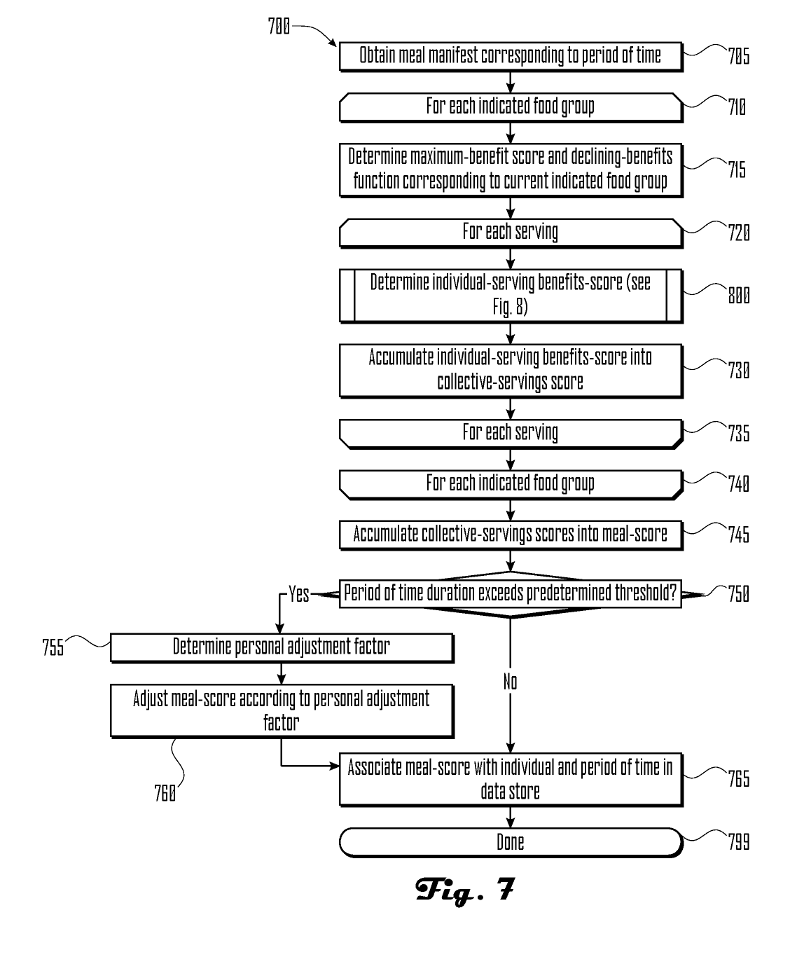

FIG. 7 illustrates a meal-scoring routine 700 for scoring a meal consumed by an individual during a period of time, such as may be performed by a meal-scoring device 900 in accordance with one embodiment.

In block 705, meal-scoring routine 700 obtains a meal manifest corresponding to the period of time, the meal manifest including a servings count that measures a plurality of servings of a food of at least one indicated food group that the individual consumed during the period of time. The meal manifest is also discussed in connection with block 305 (see FIG. 3, discussed above).

Beginning in opening loop block 710, meal-scoring routine 700 processes each indicated food group in turn.

In block 715, meal-scoring routine 700 determines a maximum-benefit score and a serving-wise declining-benefits function corresponding to the current indicated food group. Similar subject matter is discussed in connection with block 225 (see FIG. 2, discussed above) and block 230 (see FIG. 2, discussed above).

In some embodiments, the maximum-benefit score and/or the declining-benefits function are determined based at least in part on the period of time. In various embodiments, meal-scoring routine 700 may determine the maximum-benefit score and the declining-benefits function based at least in part on one or more additional factors.

For example, in some embodiments, meal-scoring routine 700 determines a serving-wise decay rate based at least in part on a duration of the period of time, such that shorter durations are associated with faster decay rates.

In some embodiments, meal-scoring routine 700 determines the serving-wise decay rate based at least in part on a measure of variety among various foods of the current indicated food group, such that food groups having higher measures of variety are associated with slower decay rates.

In some embodiments, meal-scoring routine 700 determines the serving-wise decay rate based at least in part on a measure of expected weight and/or health outcomes associated with the current indicated food group, such that food groups having better expected weight and/or health outcomes are associated with slower decay rates.

Beginning in opening loop block 720, meal-scoring routine 700 processes each serving in turn.

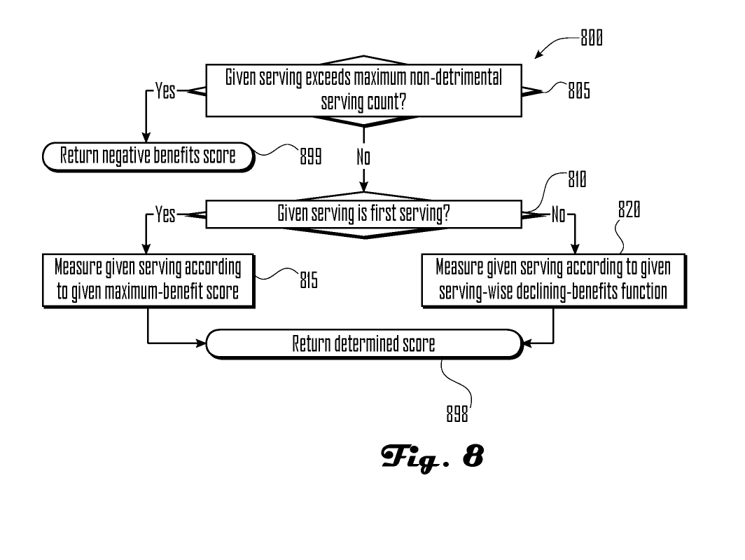

In subroutine block 800, meal-scoring routine 700 calls subroutine 800 (see FIG. 8, discussed below) to determine an individual-serving benefits-score that measures qualitative benefits associated with the current serving as consumed during the period of time. Generally a first serving is qualitatively-measured according to a maximum-benefit score (determined in block 715) and subsequent servings are qualitatively-measured according to a serving-wise declining-benefits function (also determined in block 715).

In some embodiments, determining at least one of the plurality of servings comprises determining that the at least one of the plurality of servings exceeds a maximum non-detrimental serving count, and consequently, assigning a negative benefits score to that serving.

Similar subject matter is also discussed in connection with serving-score subroutine 600 (see FIG. 6, discussed above).

In block 730, meal-scoring routine 700 accumulates the individual-serving benefits-score determined in the current iteration of subroutine block 800 into a collective-servings score. Similar subject matter is discussed in connection with block 460 (see FIG. 4, discussed above). Ultimately, the collective-servings score will measure a qualitative benefit associated with the plurality of servings consumed during the period of time.

In ending loop block 735, meal-scoring routine 700 iterates back to opening loop block 720 to process the next serving, if any.

In ending loop block 740, meal-scoring routine 700 iterates back to opening loop block 710 to process the next indicated food group, if any.

In block 745, meal-scoring routine 700 accumulates the one or more collective-servings scores (determined in one or more iterations of block 730) into a meal-score.

In decision block 750, meal-scoring routine 700 determines whether the duration of a period of time exceeds a predetermined threshold (e.g., determines whether the period of time covers an entire day, or merely a single meal). If so, meal-scoring routine 700 proceeds to block 755; otherwise, meal-scoring routine 700 proceeds to block 765.

In block 755, meal-scoring routine 700 optionally determines a personal adjustment factor based at least in part on a personal characteristic of an individual. Similar subject matter is discussed in connection with decision block 350 (see FIG. 3, discussed above).

In block 760, meal-scoring routine 700 adjusts the meal-score determined in block 745 according to the personal adjustment factor determined in block 755.

In block 765, meal-scoring routine 700 associates the meal-score with at least the individual and the period of time in a data store (e.g., in qualitative meal-scoring database 940) for subsequent presentation to and/or use by the individual.

Meal-scoring routine 700 ends in ending block 799.

FIG. 8 illustrates a subroutine 800 for determining an individual-serving benefits-score that measures qualitative benefits associated with the given serving consumed during the given period of time based at least in part on a given maximum-benefit score and a given serving-wise declining-benefits function, such as may be performed by a meal-scoring device 900 in accordance with one embodiment.

In decision block 805, subroutine 800 determines whether given serving exceeds a maximum non-detrimental serving count. A similar decision is discussed in connection with decision block 445 (see FIG. 4, discussed above). If so, subroutine 800 proceeds to ending block 899; otherwise, subroutine 800 proceeds to decision block 810.

If it is determined in decision block 805 that the given serving exceeds the maximum non-detrimental serving count, then subroutine 800 ends in ending block 899, returning a negative benefits score the caller.

Otherwise, in decision block 810, subroutine 800 determines whether the given serving is the first serving of the indicated food group that an individual has consumed during the given period of time. If so, subroutine 800 proceeds to block 815; otherwise, subroutine 800 proceeds to block 820.

If it is determined in decision block 810 that the given serving is the first serving of the indicated food group during the given period of time, then in block 815, subroutine 800 measures the given serving according to the given maximum-benefit score. Otherwise, in block 820, subroutine 800 measures the given serving according to the given declining-benefits function.

Subroutine 800 ends in ending block 898, returning to the caller the benefits score determined in block 815 or block 820.

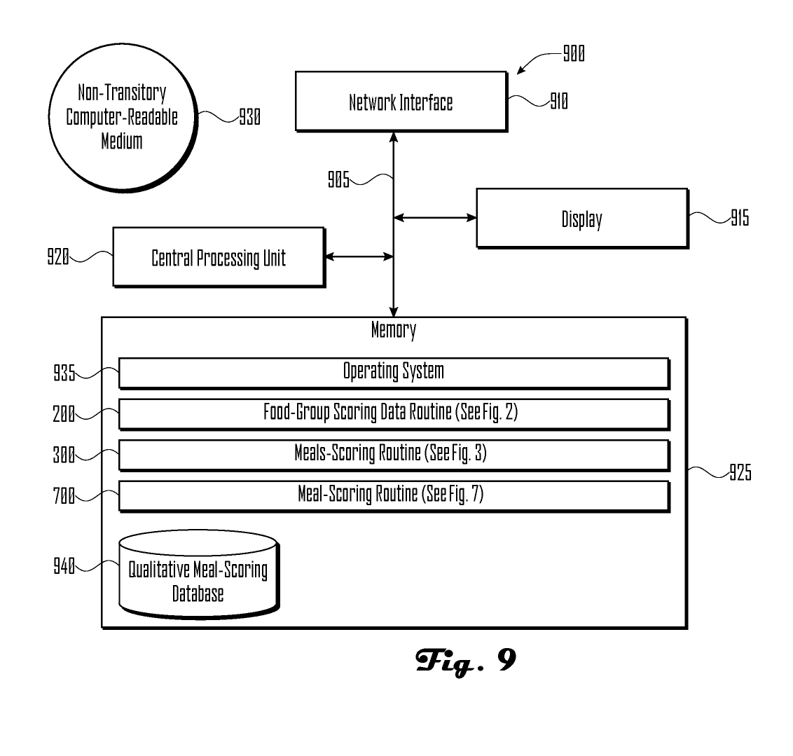

FIG. 9 illustrates several components of an exemplary meal-scoring device in accordance with one embodiment. In various embodiments, meal-scoring device 900 may include a desktop PC, server, workstation, mobile phone, laptop, tablet, set-top box, appliance, or other computing device that is capable of performing operations such as those described herein. In some embodiments, meal-scoring device 900 may include many more components than those shown in FIG. 9. However, it is not necessary that all of these generally conventional components be shown in order to disclose an illustrative embodiment.

In various embodiments, meal-scoring device 900 may comprise one or more physical and/or logical devices that collectively provide the functionalities described herein. In some embodiments, meal-scoring device 900 may comprise one or more replicated and/or distributed physical or logical devices.

In some embodiments, meal-scoring device 900 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Meal-scoring device 900 includes a bus 905 interconnecting several components including a network interface 910, a display 915, a central processing unit 920, and a memory 925.

Memory 925 generally comprises a random access memory (“RAM”) and permanent non-transitory mass storage device, such as a hard disk drive or solid-state drive. Memory 925 stores program code for a food-group scoring data routine 200 for determining one or more serving-wise scoring functions for a given food group over a given period of time (see FIG. 2, discussed above); a meals-scoring routine 300 for scoring one or more meals consumed by a given individual in a given period of time (see FIG. 3, discussed above); and a meal-scoring routine 700 for scoring a meal consumed by an individual during a period of time (see FIG. 7, discussed above). In addition, the memory 925 also stores an operating system 935.

These and other software components may be loaded into memory 925 of meal-scoring device 900 using a drive mechanism (not shown) associated with a non-transitory computer-readable medium 930, such as a floppy disc, tape, DVD/CD-ROM drive, memory card, or the like.

Memory 925 also includes qualitative meal-scoring database 940. In some embodiments, meal-scoring device 900 may communicate with qualitative meal-scoring database 940 via network interface 910, a storage area network (“SAN”), a high-speed serial bus, and/or via the other suitable communication technology.

In some embodiments, qualitative meal-scoring database 940 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A meal-scoring-device-implemented method for scoring a meal consumed by an individual during a period of time, the method comprising:
obtaining, by the meal-scoring device, a meal manifest corresponding to said period of time, said meal manifest including a servings count that measures a plurality of servings of a food of an indicated food group that said individual consumed during said period of time;
determining, by the meal-scoring device based at least in part on said period of time, a maximum-benefit score and a serving-wise declining-benefits function corresponding to said indicated food group;
determining, by the meal-scoring device, a plurality of individual-serving benefits-scores that respectively measure qualitative benefits associated with said plurality of servings consumed during said period of time, such that a first serving is qualitatively-measured according to said maximum-benefit score and subsequent servings are qualitatively-measured according to said declining-benefits function;
determining, by the meal-scoring device, a collective-servings score measuring a qualitative benefit associated with said plurality of servings consumed during said period of time, said collective-servings score being determined based at least in part on an accumulation of said plurality of individual-serving benefits-scores; and
associating, by the meal-scoring device, said collective-servings score with at least said individual and said period of time in a data store.

2. The method of claim 1, wherein determining said declining-benefits function comprises determining a serving-wise decay rate based at least in part on a duration of said period of time, such that shorter durations are associated with faster decay rates.

3. The method of claim 1, wherein determining said declining-benefits function comprises determining a serving-wise decay rate based at least in part on a measure of variety among various foods of said indicated food group, such that food groups having higher measures of variety are associated with slower decay rates.

4. The method of claim 1, wherein determining said declining-benefits function comprises determining a serving-wise decay rate based at least in part on a measure of expected weight and/or health outcomes associated with said indicated food group, such that food groups having better expected weight and/or health outcomes are associated with slower decay rates.

5. The method of claim 1, wherein determining at least one of said plurality of individual-serving benefits-scores comprises determining that at least one of said plurality of servings exceeds a maximum non-detrimental serving count, and consequently, assigning a negative benefits score to said at least one of said plurality of servings.

6. The method of claim 1, wherein determining said collective-servings score comprises, when a duration of said period of time is determined to exceed a predetermined threshold:
determining a personal adjustment factor based at least in part on a personal characteristic of said individual; and
adjusting said accumulation of said plurality of individual-serving benefits-scores according to said personal adjustment factor.

7. A computing apparatus for scoring a meal consumed by an individual during a period of time, the apparatus comprising a processor and a memory storing instructions that, when executed by the processor, configure the apparatus to:
obtain a meal manifest corresponding to said period of time, said meal manifest including a servings count that measures a plurality of servings of a food of an indicated food group that said individual consumed during said period of time;
determine, based at least in part on said period of time, a maximum-benefit score and a serving-wise declining-benefits function corresponding to said indicated food group;
determine a plurality of individual-serving benefits-scores that respectively measure qualitative benefits associated with said plurality of servings consumed during said period of time, such that a first serving is qualitatively-measured according to said maximum-benefit score and subsequent servings are qualitatively-measured according to said declining-benefits function;
determine a collective-servings score measuring a qualitative benefit associated with said plurality of servings consumed during said period of time, said collective-servings score being determined based at least in part on an accumulation of said plurality of individual-serving benefits-scores; and
associate said collective-servings score with at least said individual and said period of time in a data store.

8. The apparatus of claim 7, wherein the instructions that configure the apparatus to determine said declining-benefits function further comprise instructions configuring the apparatus to determine a serving-wise decay rate based at least in part on a duration of said period of time, such that shorter durations are associated with faster decay rates.

9. The apparatus of claim 7, wherein the instructions that configure the apparatus to determine said declining-benefits function further comprise instructions configuring the apparatus to determine a serving-wise decay rate based at least in part on a measure of variety among various foods of said indicated food group, such that food groups having higher measures of variety are associated with slower decay rates.

10. The apparatus of claim 7, wherein the instructions that configure the apparatus to determine said declining-benefits function further comprise instructions configuring the apparatus to determine a serving-wise decay rate based at least in part on a measure of expected weight and/or health outcomes associated with said indicated food group, such that food groups having better expected weight and/or health outcomes are associated with slower decay rates.

11. The apparatus of claim 7, wherein the instructions that configure the apparatus to determine at least one of said plurality of individual-serve benefits-scores further comprise instructions configuring the apparatus to determining that at least one of said plurality of servings exceeds a maximum non-detrimental serving count, and consequently, assigning a negative benefits score to said at least one of said plurality of servings.

12. The apparatus of claim 7, wherein the instructions that configure the apparatus to determine said collective-servings score further comprise instructions configuring the apparatus to, when a duration of said period of time is determined to exceed a predetermined threshold:
determine a personal adjustment factor based at least in part on a personal characteristic of said individual; and
adjust said accumulation of said plurality of individual-serving benefits-scores according to said personal adjustment factor.

13. A non-transitory computer-readable storage medium having stored thereon instructions including instructions that, when executed by a processor, configure the processor to:
obtain a meal manifest corresponding to a period of time, said meal manifest including a servings count that measures a plurality of servings of a food of an indicated food group that an individual consumed during said period of time;
determine, based at least in part on said period of time, a maximum-benefit score and a serving-wise declining-benefits function corresponding to said indicated food group;
determine a plurality of individual-serving benefits-scores that respectively measure qualitative benefits associated with said plurality of servings consumed during said period of time, such that a first serving is qualitatively-measured according to said maximum-benefit score and subsequent servings are qualitatively-measured according to said declining-benefits function;
determine a collective-servings score measuring a qualitative benefit associated with said plurality of servings consumed during said period of time, said collective-servings score being determined based at least in part on an accumulation of said plurality of individual-serving benefits-scores; and
associate said collective-servings score with at least said individual and said period of time in a data store.

14. The non-transitory computer-readable storage medium of claim 13, wherein the instructions that configure the processor to determine said declining-benefits function further comprise instructions configuring the processor to determine a serving-wise decay rate based at least in part on a duration of said period of time, such that shorter durations are associated with faster decay rates.

15. The non-transitory computer-readable storage medium of claim 13, wherein the instructions that configure the processor to determine said declining-benefits function further comprise instructions configuring the processor to determine a serving-wise decay rate based at least in part on a measure of variety among various foods of said indicated food group, such that food groups having higher measures of variety are associated with slower decay rates.

16. The non-transitory computer-readable storage medium of claim 13, wherein the instructions that configure the processor to determine said declining-benefits function further comprise instructions configuring the processor to determine a serving-wise decay rate based at least in part on a measure of expected weight and/or health outcomes associated with said indicated food group, such that food groups having better expected weight and/or health outcomes are associated with slower decay rates.

17. The non-transitory computer-readable storage medium of claim 13, wherein the instructions that configure the processor to determine at least one of said plurality of individual-serve benefits-scores further comprise instructions configuring the processor to determining that at least one of said plurality of servings exceeds a maximum non-detrimental serving count, and consequently, assigning a negative benefits score to said at least one of said plurality of servings.

18. The non-transitory computer-readable storage medium of claim 13, wherein the instructions that configure the processor to determine said collective-servings score further comprise instructions configuring the processor to, when a duration of said period of time is determined to exceed a predetermined threshold:
determine a personal adjustment factor based at least in part on a personal characteristic of said individual; and
adjust said accumulation of said plurality of individual-serving benefits-scores according to said personal adjustment factor.
